(19) United States
(12) Patent Application Publication
(10) Pub. No.: US 2025/0104122 A1
(43) Pub. Date: Mar. 27, 2025

(54) ITEM DISTRIBUTION CONTROL DEVICE, ITEM DISTRIBUTION CONTROL PROGRAM, ITEM DISTRIBUTION CONTROL METHOD, VR TERMINAL, VR TERMINAL PROGRAM, AND VR TERMINAL CONTROL METHOD

(71) Applicant: DENTSU INC., Tokyo (JP)

(72) Inventors: Mihoko HOTTA, Tokyo (JP); Ryo SUETOMI, Tokyo (JP); Kazuhiro SHIDA, Tokyo (JP); Yu NISHIMUTA, Tokyo (JP)

(73) Assignee: DENTSU INC., Tokyo (JP)

(21) Appl. No.: 18/723,769

(22) PCT Filed: Dec. 19, 2022
(86) PCT No.: PCT/JP2022/046580

§ 371 Date: Jun. 24, 2024

(30) Foreign Application Priority Data
Dec. 27, 2021 (JP) 2021-212474

(51) Int. Cl. G06Q 30/0601

(52) U.S. Cl. CPC G06Q 30/0611; G06Q 30/0643

(57) ABSTRACT

Provided are: an item distribution control device that promotes the distribution of an item in a VR space; an item distribution control program and an item distribution control method; a VR terminal used therefor; a program for a VR terminal; and a VR terminal control method. The present invention controls the distribution of an item by: accepting, from a first user who has item ownership rights and resale rights, either a first sale offer offering to sell the item ownership rights and resale rights, as a set, to another user, or a second sale offer offering to sell only the item ownership rights to another user; accepting, from a second user, either a first purchase offer offering to purchase the item ownership rights and resale rights, as a set, from the first user, or a second purchase offer offering to purchase only the item ownership rights from the first user; and registering, in a user information database, information indicating which user has item ownership rights and resale rights.

### TECHNICAL FIELD

The present invention relates to an item distribution control device, an item distribution control program, an item distribution control method, a VR terminal, a VR terminal program, and a VR terminal control method.

### BACKGROUND ART

Patent Literature 1 discloses an information reproducing device capable of distributing content (officially copied contents) copied by the proper route in a more advantageous form than contents copied without proper authorization. However, Patent Literature 1 does not consider distribution in a VR space.

### CITATION LIST

### Patent Literature

### Patent Literature 1: JP 2008-210504 A

### SUMMARY OF INVENTION

### Technical Problem

An object of the present invention is to provide an item distribution control device, an item distribution control program, and an item distribution control method which promote distribution of an item in a VR space, and a VR terminal, a VR terminal program, and a VR terminal control method which can be used for the item distribution control device, the item distribution control program, and the item distribution control method.

### Solution to Problem

According to one mode of the present invention, there is provided an item distribution control device that controls distribution of an item usable in a VR space, the item distribution control device comprising: a sales offer receiver capable of receiving, from a first user having ownership and a sale right of the item, a first sales offer for offering to sell a set of the ownership and a resale right of the item to another user, and a second sales offer for offering to sell only the ownership of the item to another user; a purchase offer receiver in a case where the second sales offer is received, capable of receiving only a second purchase offer from another user among a first purchase offer for offering to purchase the set of the ownership and the resale right of the item from the first user and the second purchase offer for offering to purchase only the ownership of the item from the first user, and in a case where the first sales offer is received, capable of receiving the first purchase offer or the second purchase offer from another user according to a choice of the another user; and an information manager that registers first information indicating that a second user has the ownership and the resale right of the item in a user information database in a case where the first purchase offer is received from the second user, and registers second information indicating that the second user has the ownership of the item but does not have the resale right in the user information database in a case where the second purchase offer is received from the second user, wherein the sales offer receiver is capable of receiving a third sales offer for offering to sell the set of the ownership and the resale right of the item to another user and a fourth sales offer for offering to sell only the ownership of the item to another user from the second user in a case where the first information is registered, and is incapable of receiving the third sales offer and the fourth sales offer from the second user in a case where the second information is registered.

The distribution of the item is promoted by selling not only the ownership but also the resale right as a set.

A settlement manager, which collects a consideration for the item from the second user and gives at least a part of the consideration to the first user in a case where the first purchase offer or the second purchase offer is received from the second user, may be included.

Since the consideration is given to the first user who has sold the item, the first user is highly motivated to the sale and the distribution of the item is promoted.

The purchase offer receiver may be in a case where the fourth sales offer is received, capable of receiving only a fourth purchase offer from another user among a third purchase offer for offering to purchase the set of the ownership and the resale right of the item from the second user and the fourth purchase offer for offering to purchase only the ownership of the item from the second user, and in a case where the third sales offer is received, capable of receiving the third purchase offer or the fourth purchase offer from another user according to a choice of the another user, and the information manager registers third information indicating that a third user has the ownership and the resale right of the item in the user information database in a case where the third purchase offer is received from the third user, and registers fourth information indicating that the third user has the ownership of the item but does not have the resale right in the user information database in a case where the fourth purchase offer is received from the third user.

Since the second user who has purchased the item from the first user can further sell the item to the third user, the distribution of the item is promoted.

A settlement manager, which collects a first consideration for the item from the second user and gives at least a part of the first consideration to the first user in a case where the first purchase offer or the second purchase offer is received from the second user, and collects a second consideration for the item from the third user, gives a part of the second consideration to the first user, and gives at least a remaining part to the second user in a case where the third purchase offer or the fourth purchase offer is received from the third user, may be included.

Since the consideration is also given to the second user who resells the item, the second user is motivated to the resale, and the distribution of the item is promoted.

Information indicating that the first user has the ownership and the sale right of the item may be registered in the user information database before the first sales offer or the second sales offer is received from the first user, and the information indicating that the first user has the ownership and the sale right of the item may be maintained in both cases where the first information is registered and where the second information is registered.

Since the first user who has sold the item also continues to own and can sell the item, the same item can be sold to a plurality of other users, and the distribution of the item is promoted.

The purchase offer receiver may be capable of receiving the first purchase offer or the second purchase offer from a plurality of other users.

The same item can be sold to the plurality of other users, and the distribution of the item is promoted.

A lending offer receiver capable of receiving, from the first user, a lending offer for offering to lend the item to another user, and a borrowing offer receiver capable of receiving, from another user, a borrowing offer for offering to borrow the item from the first user may be included, and the information manager may register fifth information indicating that a fourth user has temporary ownership of the item in the user information database in a case where the borrowing offer is received from the fourth user in response to the lending offer.

Purchase can be promoted by lending (for example, trial fitting of the item) before the purchase, and the distribution of the item is promoted.

A lending time for lending the item to another user may be set in the lending offer, and the information manager may register sixth information indicating that the fourth user does not have primary ownership of the item in the item information database when a period of time according to the lending time elapses from the registration of the fifth information.

When the lending time is set, it is possible to prevent a user to whom the item is lent from using the item without limitation, and a user performing sale can perform lending without anxiety.

An available area in the VR space of the item to be lent may be set in the lending offer.

When the available area is set, it is possible to prevent the user to whom the item is lent from using the item without limitation, and the user performing sale can perform lending without anxiety.

According to another mode of the present invention, there is provided an item distribution control program for controlling distribution of an item usable in a VR space, the item distribution control program causing a computer to function as: a sales offer receiver capable of receiving, from a first user having ownership and a sale right of the item, a first sales offer for offering to sell a set of the ownership and a resale right of the item to another user, and a second sales offer for offering to sell only the ownership of the item to another user; a purchase offer receiver in a case where the second sales offer is received, capable of receiving only a second purchase offer from another user among a first purchase offer for offering to purchase the set of the ownership and the resale right of the item from the first user and the second purchase offer for offering to purchase only the ownership of the item from the first user, and in a case where the first sales offer is received, capable of receiving the first purchase offer or the second purchase offer from another user according to a choice of the another user; and an information manager that registers first information indicating that a second user has the ownership and the resale right of the item in a user information database in a case where the first purchase offer is received from the second user, and registers second information indicating that the second user has the ownership of the item but does not have the resale right in the user information database in a case where the second purchase offer is received from the second user, wherein the sales offer receiver is capable of receiving a third sales offer for offering to sell the set of the ownership and the resale right of the item to another user and a fourth sales offer for offering to sell only the ownership of the item to another user from the second user in a case where the first information is registered, and is incapable of receiving the third sales offer and the fourth sales offer from the second user in a case where the second information is registered.

According to still another mode of the present invention, there is provided an item distribution control method for controlling distribution of an item usable in a VR space, the item distribution control method comprising: enabling a sales offer receiver to receive, from a first user having ownership and a sale right of the item, a first sales offer for offering to sell a set of the ownership and a resale right of the item to another user, and a second sales offer for offering to sell only the ownership of the item to another user; enabling a purchase offer receiver in a case where the second sales offer is received, to receive only a second purchase offer from another user among a first purchase offer for offering to purchase the set of the ownership and the resale right of the item from the first user and the second purchase offer for offering to purchase only the ownership of the item from the first user, and in a case where the first sales offer is received, to receive the first purchase offer or the second purchase offer from another user according to a choice of the another user; and a step of causing an information manager to register first information indicating that a second user has the ownership and the resale right of the item in a user information database in a case where the first purchase offer is received from the second user, and to register second information indicating that the second user has the ownership of the item but does not have the resale right in the user information database in a case where the second purchase offer is received from the second user, wherein the sales offer receiver is capable of receiving a third sales offer for offering to sell the set of the ownership and the resale right of the item to another user and a fourth sales offer for offering to sell only the ownership of the item to another user from the second user in a case where the first information is registered, and is incapable of receiving the third sales offer and the fourth sales offer from the second user in a case where the second information is registered.

According to still another mode of the present invention, there is provided a VR terminal used by a user, the VR terminal comprising a controller that refers to an owned item information database indicating an item for which the user has ownership and a sale right and an item for which the user has ownership and does not have a sale right, is capable of transmitting a first sales offer for offering to sell a set of the ownership and a resale right of the item to another user or a second sales offer for offering to sell only the ownership of the item to another user according to a choice of the user for the item for which the ownership and the sale right are owned, and is incapable of transmitting the first sales offer but capable of transmitting only the second sales offer for the item for which the ownership is owned but the sale right is not owned.

According to still another mode of the present invention, there is provided a VR terminal program causing a VR terminal used by a user to function as a controller that refers to an owned item information database indicating an item for which the user has ownership and a sale right and an item for which the user has ownership and does not have a sale right, is capable of transmitting a first sales offer for offering to sell a set of the ownership and a resale right of the item to another user or a second sales offer for offering to sell only the ownership of the item to another user according to a choice of the user for the item for which the ownership and the sale right are owned, and is incapable of transmitting the first sales offer but capable of transmitting only the second sales offer for the item for which the ownership is owned but the sale right is not owned.

According to still another mode of the present invention, there is provided a VR terminal control method, wherein a VR terminal used by a user refers to an owned item information database indicating an item for which the user has ownership and a sale right and an item for which the user has ownership and does not have a sale right, is capable of transmitting a first sales offer for offering to sell a set of the ownership and a resale right of the item to another user or a second sales offer for offering to sell only the ownership of the item to another user according to a choice of the user for the item for which the ownership and the sale right are owned, and is incapable of transmitting the first sales offer but capable of transmitting only the second sales offer for the item for which the ownership is owned but the sale right is not owned.

### Advantageous Effects of Invention

The distribution of the item can be promoted in the VR space.

### BRIEF DESCRIPTION OF DRAWINGS

FIG. 1 is a diagram for describing an outline of an embodiment of the present invention.

FIG. 2 is a schematic configuration diagram of a distribution management system according to the embodiment.

FIG. 3 is a view schematically illustrating an example of an owned item information database.

FIG. 4 is a view schematically illustrating an example of a user information database.

FIG. 5 is a view schematically illustrating an example of an item information database.

FIG. 6 is a sequence diagram illustrating an example of processing operations of an item distribution control system.

### DESCRIPTION OF EMBODIMENTS

Hereinafter, an embodiment according to the present invention will be specifically described with reference to the drawings.

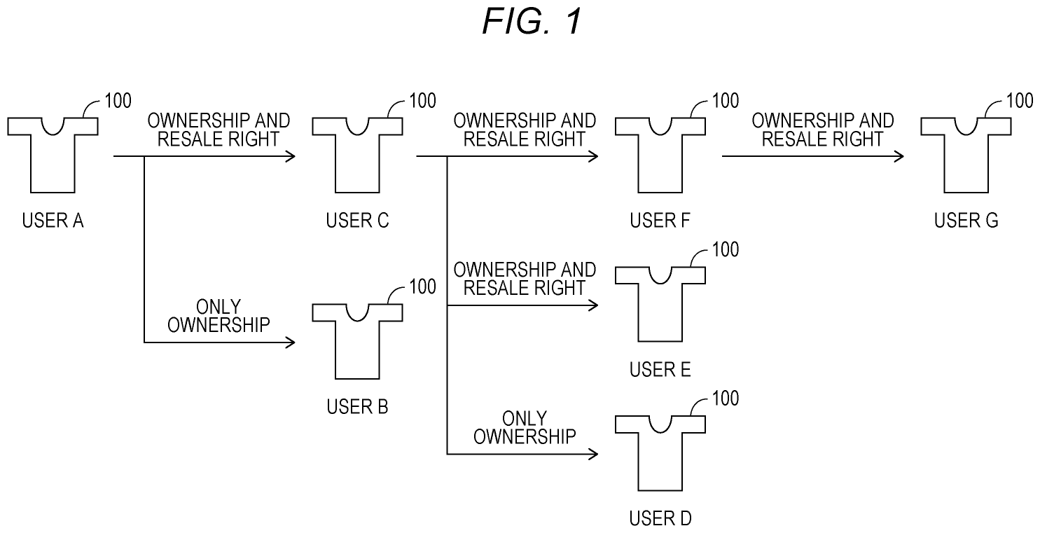

FIG. 1 is a diagram illustrating an outline of an embodiment of the present invention. The present embodiment relates to an item distribution control system that controls distribution of a virtual item that can be used in a virtual reality (VR) space.

In an example of FIG. 1, a certain user A owns an original of an item 100 that can be used in the VR space. The item 100 is, for example, a virtual garment, and can be won on a body of an avatar corresponding to the user A in the VR space. Then, the user A can sell the item 100 to another user. That is, the user A has ownership and a sale right of the item 100.

One of features of the present embodiment is two modes of selling. One of them is a mode of selling the ownership and a resale right of the item 100 to another user (hereinafter, sometimes referred to as “sale with the resale right” or the like). The other is a mode of selling only the ownership of the item 100 to another user (hereinafter, sometimes referred to as “sale of only ownership” or the like). The user A can personally select any mode of selling.

Another user who has purchased the ownership and the resale right of the item 100 can not only use the item 100 personally in the VR space but also resell (resale) the item to other users. That is, a user who has purchased the item 100 with the resale right himself/herself can also be a seller of the item. On the other hand, another user who has purchased only the ownership of the item 100 can only use the item 100 personally in the VR space and cannot resell the item to other users.

In the example of FIG. 1, the user A sells only the ownership of the item 100 to a user B. Thus, the user B cannot resell the item 100 to another user. In addition, the user A sells the ownership and the resale right of the item 100 to a user C. Then, the user C resells only the ownership of the item 100 to a user D, and resells the ownership and the resale right to users E and F.

Note that the user who owns the original of the item 100 (for example, a user who has produced the item 100 or a user having a copyright of the item 100) is sometimes referred to as a “primary owner user” or an “original owner user”. In addition, a user who has acquired the item 100 from an nth-order owner user is sometimes referred to as an “(n+1)th-order owner user”.

As another feature of the present embodiment, the sale of ownership is to grant a copy of the item 100 to another user, and a selling user still owns the item 100 in any mode of selling. Thus, the user who owns the item 100 can sell the item 100 to a plurality of other users. As a result, the distribution of the item 100 is promoted.

In the example of FIG. 1, the user A sells the item 100 to the plurality of users B and C. In addition, the user C sells the item 100 to the plurality of users D to F.

In addition, in a case where the item 100 is purchased from the nth-order owner user, a predetermined consideration (for example, money, the same applies hereinafter) is collected. It goes without saying that a part thereof is given to the nth-order owner user, but as still another feature of the present embodiment, the remaining part is also given to (at least some of) the primary to (n−1)th-order owner users. As a result, motivation to purchase the resale right and sell the item 100 to another user is increased even for secondary and subsequent owner users, and the distribution of the item 100 is promoted.

In the example of FIG. 1, a part of money collected when the user D purchases the item 100 from the secondary owner user C is given to the secondary owner user C, and the other part is given to the primary owner user A. Note that a part of money may be given to the user B who is the secondary owner user, but no money may be given to the user B since the user B is not involved in the distribution of the item 100 from the primary owner user to the user D.

In addition, a part of money collected when a user G purchases the item 100 from the tertiary owner user F is given to the tertiary owner user F, another part is given to the secondary owner user C, and the other part is given to the primary owner user A.

Note that one or more of the features described above may be omitted. Hereinafter, a specific description will be given.

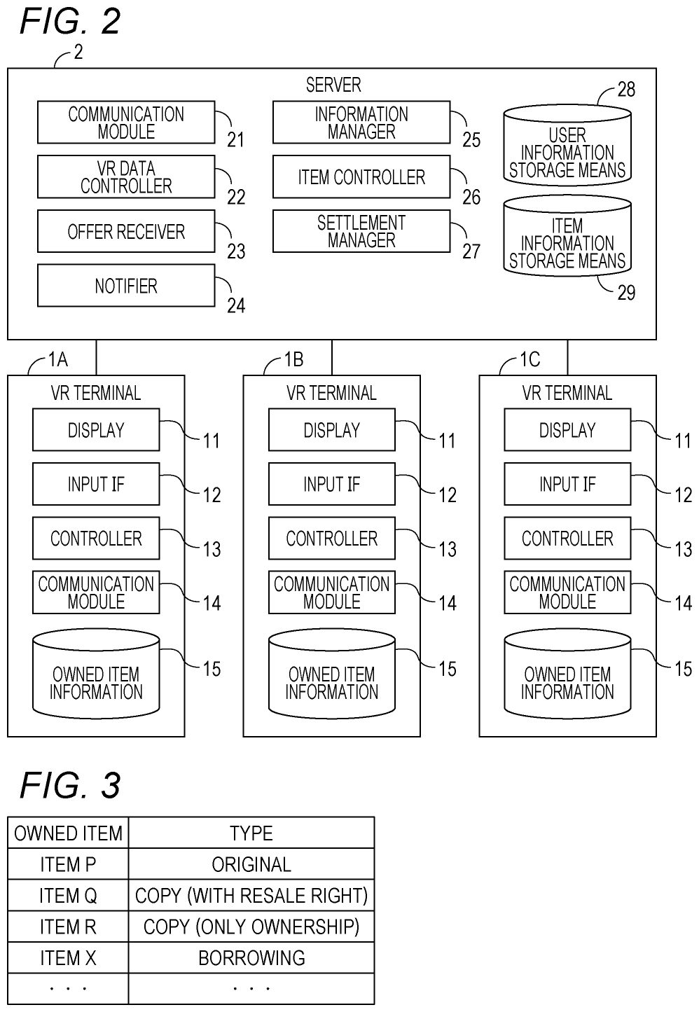

FIG. 2 is a schematic configuration diagram of a distribution management system according to the embodiment. The distribution management system includes VR terminals 1A to 1C used by the users A to C, respectively, and a server 2 (item distribution control device). Note that three users A to C are illustrated in FIG. 1, but the number of users is not limited.

Since the VR terminals 1A to 1C have a common configuration, the VR terminal 1A will be described as a representative. The VR terminal 1A may be any computer such as a head mount display (HMD), a personal computer, a smartphone, or a tablet terminal. The VR terminal 1A includes a display 11, an input interface 12, a controller 13, a communication module 14, an owned item information storage means 15, and the like.

The display 11 can display a VR space. In the VR space, the user A can activate an avatar (hereinafter referred to as an “avatar A”) that is a virtual character corresponding to himself/herself. Then, the avatar can use various items in the VR space. As an example, the items are virtual garments, and the avatar corresponding to the user A can wear a garment in the VR space when an item is used.

The input interface 12 is a touch panel, a button, a VR controller, a sensor, or the like, and receives an input from the user A.

The controller 13 displays the VR space on the display 11 on the basis of VR data (described later) received from the server 2. The displayed VR space may be one in which the VR space is viewed from the viewpoint of the avatar A or may be one in which the avatar A is viewed from the viewpoint of a third party.

In addition, the controller 13 transmits an instruction for activating the avatar A in the VR space to the server 2 on the basis of the input of the user A via the input interface 12. That is, the user A can activate the avatar A in the VR space via the input interface 12. As a specific example, the user A can move the avatar A in the VR space, have a conversation with another avatar in the VR space, and use an item for which ownership is owned in the VR space.

In addition, the controller 13 transmits a sales offer for offering to sell an item for which a sale right is owned to another user to the server 2 on the basis of the input of the user A via the input interface 12. That is, the user A can sell the item for which the sale right is owned to another user via the input interface 12. Note that the sale (sale right) in the present specification includes the resale (resale right). There are two types of sales offers as follows.

One of the sales offers is an offer to sell a set of ownership and a resale right of an owned item to another user (hereinafter referred to as a “sales offer with the resale right”). The user who has acquired the item from the user A in response to the sales offer with the resale right can use the item in the VR space and resell the item to another user.

The other of the sales offers is an offer to sell only ownership without selling a resale right of an owned item to another user (hereinafter referred to as a “sales offer with only ownership”). The user who has acquired the item from the user A in response to the sales offer with only ownership can use the item in the VR space, but cannot resell the item to another user.

For an item for which a sale right is owned, the user A can make the sales offer with the resale right or can make the sales offer with only ownership according to his/her choice. On the other hand, the user A cannot make the sales offer with the resale right for an item for which ownership is owned but a sale right is not owned.

It can also be said that a sales offer is associated with an item to be sold. In addition, even in a case where any sales offer is transmitted, the user A who is an owner of an item to be sold can continue to use the item in the VR space and sell the item to other users even after the item is sold to another user.

In addition, the controller 13 transmits a lending offer for offering to lend (temporary ownership of) an item for which a sale right is owned to another user to the server 2 on the basis of the input of the user A via the input interface 12. That is, the user A can lend the item for which the sale right is owned to another user via the input interface 12. Lending is, for example, trial (trial fitting in a case where an item is a garment or the like) or rental. In addition, it can also be said that a lending offer is associated with an item to be lent.

In addition, the controller 13 transmits a purchase offer for offering to purchase an item associated with a sales offer from another user to the server 2 on the basis of the input of the user A via the input interface 12. That is, the user A can purchase the item from another user in response to the sales offer from the another user via the input interface 12. There are two types of purchase offers as follows.

One of the purchase offers is an offer to purchase a set of ownership and a resale right of an item from a selling user (hereinafter referred to as a “purchase offer with the resale right”). The user A who has purchased the item from another user through the purchase offer with the resale right can use the item in the VR space and resell the item to other users.

The other of the purchase offers is an offer to purchase only ownership of an item from a selling user (hereinafter referred to as “purchase offer with only ownership”). The user A who has purchased the item from another user through the purchase offer with only ownership can use the item in the VR space, but cannot resell the item to other users.

In a case where the sales offer with the resale right is made by another user, the user A can make the purchase offer with the resale right or can make the purchase offer with only ownership according to his/her choice. On the other hand, in a case where the sales offer with only ownership is made from another user, the user A can make only the purchase offer with only ownership.

In addition, the controller 13 transmits a borrowing offer for offering to borrow (temporarily own) an item associated with a lending offer from another user on the basis of the input of the user A to the server 2 via the input interface 12. That is, the user A can borrow the item from another user in response to the lending offer from the another user via the input interface 12.

In addition, the controller 13 accesses the owned item information storage means 15 at an appropriate timing as necessary, and refers to and updates an owned item information database stored in the owned item information storage means 15.

FIG. 3 is a view schematically illustrating an example of the owned item information database. Owned item information in the owned item information database is obtained by associating an item owned by a user with a type of the item. The type is any of an original (for which ownership and a sale right are owned), a copy (for which ownership and a resale right are owned) purchased with the resale right from another user, a copy (for which only ownership is owned) for which only the ownership is purchased from another user, and borrowing (for which only temporary ownership is owned).

In the example of FIG. 3, the user A owns an original of an item P, a copy of an item Q purchased with a resale right from another user, and a copy of an item R for which only ownership is purchased from another user. In addition, the user A temporarily owns an item X borrowed from another user.

For the original item or the item owned as the copy with the resale right, the user A can make the sales offer with the resale right according to his/her choice (input on the input interface 12) or can make the sales offer with only ownership. That is, the controller 13 can refer to the owned item information database and transmit the sales offer with the resale right or transmit the sales offer with only ownership for the item for which the ownership and the sale right are owned.

On the other hand, the user A cannot make the sales offer with the resale right and the sales offer with only ownership for the item owned as the copy with only ownership. That is, the controller 13 can refer to the owned item information database and transmit neither the sales offer with the resale right nor the sales offer with only ownership for the item for which only the ownership is owned.

Some or all of the above-described functions of the controller 13 may be implemented by hardware or may be achieved as a processor of the VR terminal 1A executes a predetermined program. In addition, the owned item information storage means 15 is not necessarily built in the VR terminal 1A as long as it can be accessed by the controller 13 of the VR terminal 1A.

The communication module 14 transmits and receives data to and from the server 2. As an example, the communication module 14 transmits, to the server 2, an instruction from the user A for activating the avatar A in the VR space, a sales offer, a lending offer, a purchase offer, a borrowing offer, and the like. In addition, the communication module 14 receives, from the server 2, the VR data necessary for displaying the VR space and data necessary for updating the owned item information database.

Meanwhile, the server 2 includes a communication module 21, a VR data controller 22, an offer receiver 23, a notifier 24, an information manager 25, an item controller 26, a settlement manager 27, a user information storage means 28, and an item information storage means 29.

The communication module 21 transmits and receives data to and from each of the VR terminals 1A to 1C. As an example, the communication module 21 receives, from the VR terminals 1A to 1C, instructions from the users A to C for activating avatars in the VR space, a sales offer, a lending offer, a purchase offer, a borrowing offer, and the like. In addition, the communication module 21 transmits the VR data and some or all of user information or item information, which will be described later, to each of the VR terminals 1A to 1C.

The VR data controller 22 generates and updates the VR data necessary for displaying the VR space on the display 11 of each of the VR terminals 1A to 1C. This VR data may include, for example, information on where and which avatar is present in the VR space, information on which item is used by each avatar, information that needs to be displayed in the VR space, information on various offers made by each user, and the like.

The offer receiver 23 can receive, via the communication module 21, a sales offer, a lending offer, a purchase offer, a borrowing offer, and the like transmitted from the VR terminals 1A to 1C.

The notifier 24 notifies (a VR terminal of) another user of various offers from a certain user. For example, in a case where a sales offer for a certain item has been received from the user A, another user is notified of the fact that the item can be purchased from the user A. In addition, in a case where a lending offer for a certain item has been received from the user A, another user is notified of the fact that the item can be borrowed from the user A. Any notification technique can be used, and for example, the notification may be displayed in the VR space, or another user may be notified in a place different from the VR space such as an email.

The information manager 25 manages a user information database stored in the user information storage means 28 and an item information database stored in the item information storage means 29.

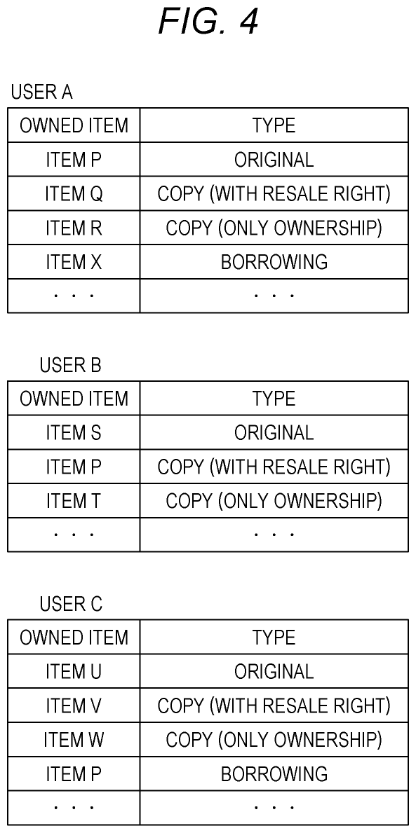

FIG. 4 is a view schematically illustrating an example of the user information database. The user information in the user information database is obtained, for each user, by associating an item owned by the user with a type of the item. The user information illustrated in FIG. 4 corresponds to the owned item information illustrated in FIG. 3. This user information database can also be said to be a virtual closet in the VR space.

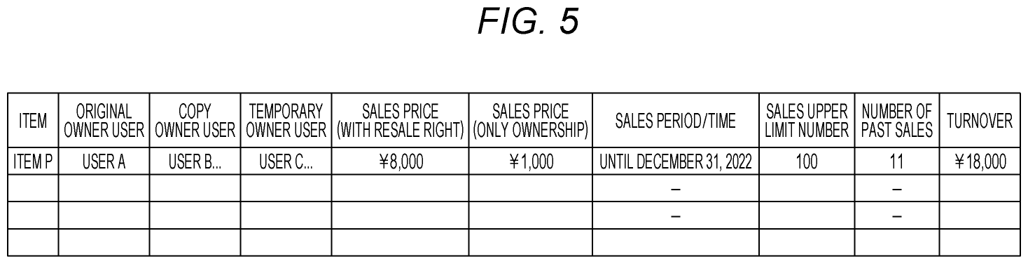

FIG. 5 is a view schematically illustrating an example of the item information database. The item information in the item information database is obtained by associating each item with various types of information.

As the item information, an item, an original owner user (primary owner user) who is a user owning an original of the item, a copy owner user (secondary or subsequent owner user) who is a user having purchased the item from the original owner user directly or indirectly via another user, and a user temporarily owning (borrowing) the item are associated with each other.

In the example of FIG. 5, regarding the item P, the original owner user is the user A, the copy owner user is the user B or the like, and the temporary owner user is the user C and the like.

As the item information, an item is associated with a sales price of the item. The sales price includes a price (a value of consideration) of money that needs to be paid by another user in a case where the item is sold to the another user with a resale right, and a price (a value of consideration) of money that needs to be paid by another user in a case where only the ownership of the item is sold to the another user. The former can be regarded as a buyer price, and the latter can be regarded as a general price.

One or both of these sales prices may be a predetermined fixed value, and may be settable by the original owner user via the input interface 12 of the VR terminal or settable by a selling user (either the original owner user or the copy owner user). The sales price may be a fixed amount regardless of the order of distribution, or may be set for each distribution. Note that a sales price (value of consideration) in a case of the sale with the resale right is desirably higher than a sales price (value of consideration) in a case of the sale of only ownership.

In the example of FIG. 5, regarding the item P, a sales price with a resale right is 8,000 yen, and a sales price with only ownership is 1,000 yen.

As the item information, an item is associated with a sales period/time and a sales upper limit number of the item. The sales period/time of the item indicates a period or time during which the item can be sold from the original owner user or the copy owner user having the resale right to another user. The sales upper limit number is an upper limit number of times the original owner user or the copy owner user having the resale right can sell the item to another user. That is, an upper limit number of the number of times the item can be copied corresponds to the sales upper limit number. One or all of the sales period/time and the sales upper limit number may be a predetermined fixed value, or may be settable by the original owner user via the input interface 12 of the VR terminal.

In the example of FIG. 5, regarding the item P, the sales period/time is until Dec. 31, 2022, and the sales upper limit number is 100.

As the item information, an item is associated with the number of past sales and a turnover of the item. The number of past sales indicates the number of times the item has been sold. The number of past sales is controlled not to exceed the sales upper limit number. The turnover is a total amount of sales when the original owner user and the copy owner user having the resale right sell items to other users.

In the example of FIG. 5, regarding the item P, the number of times of the sale with the resale right is 1, the number of times of the sale with only ownership is 10, the number of past sales is 11, and the turnover is 18,000 yen.

In addition, an item is associated with a person excluded from customers of the item as the item information. The person excluded from customers may also be settable by the original owner user. In addition, the item may be associated with an amount to be paid to the primary to (n−1)th-order owner when the nth-order owner purchases the item. The amount may be a fixed amount regardless of the order of distribution, or may be set for each distribution.

Some or all of the user information and the item information described above can be transmitted to the VR terminals 1A to 1C at an appropriate timing as necessary, and can be shared between the server 2 and the VR terminals 1A to 1C.

Returning to FIG. 2, the item controller 26 copies or erases an item that is digital data.

The settlement manager 27 makes a settlement accompanying the sale of an item. Specifically, the settlement manager 27 collects money corresponding to a purchase price from a user who purchases the item. A collection method is not particularly limited, and is, for example, credit card payment. Then, the settlement manager 27 deposits part or all of the collected money to the selling user. As described above, the remaining part of money collected from the nth-order owner user may also be deposited into the primary to (n−1)th-order owner users involved in the distribution of the item. Note that a part of the collected money may be deposited to a system administrator.

Some or all of the functions of the respective units of the server 2 described above may be implemented by hardware or may be achieved as a processor of the server 2 executes a predetermined program.

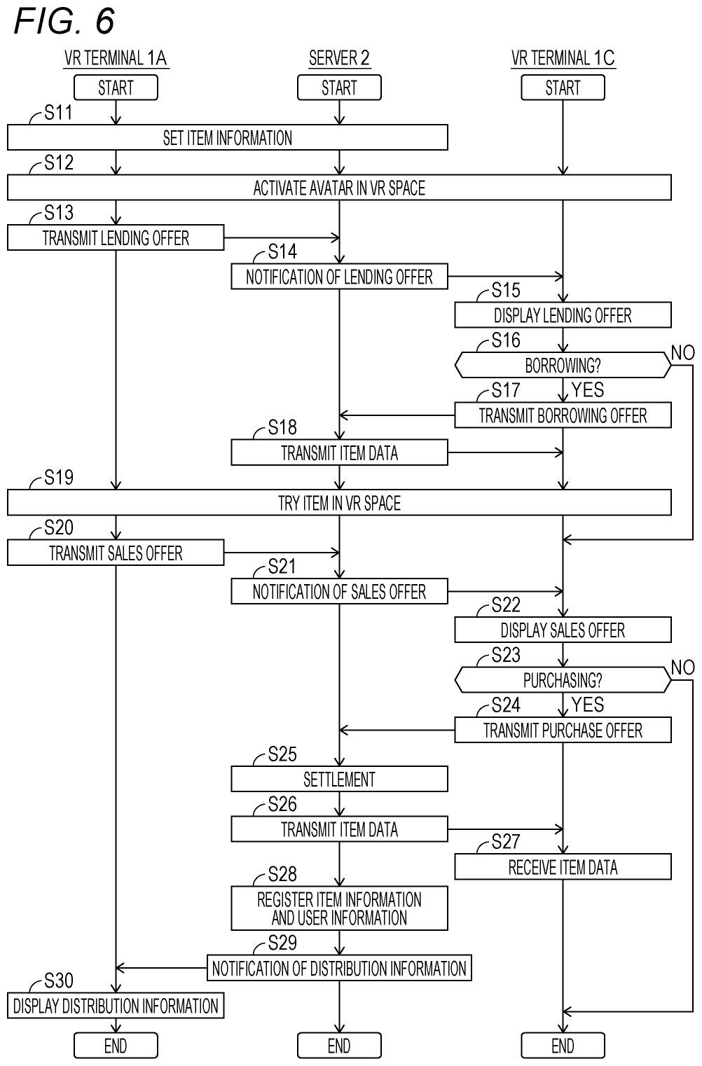

FIG. 6 is a sequence diagram illustrating an example of processing operations of the item distribution control system. Hereinafter, a case where the user A sells the item P (FIGS. 3 to 5) to the user C will be described as an example.

The user A who is the original owner user of the item P sets information regarding the item P in advance. That is, the user A uses the input interface 12 of the VR terminal 1A to arbitrarily input some or all of the sales price, the sales period/time, and the sales upper limit number illustrated in FIG. 5. The inputted data is transmitted from the VR terminal 1A to the server 2. On the basis of this data, the information manager 25 sets the information regarding the item P in the item information database in the item information storage means 29.

In this manner, the VR terminal 1A and the information manager 25 of the server 2 cooperate to set the item information in response to an instruction of the user A (step S11).

The users A and C activate (move or the like) the avatar A and an avatar C corresponding to the users A and C, respectively, in the VR space. That is, the user A uses the input interface 12 of the VR terminal 1A to issue an instruction for activating the avatar A in the VR space. This instruction is transmitted from the VR terminal 1A to the server 2. Similarly, an instruction for activating the avatar C in the VR space is transmitted from the VR terminal 1C to the server 2. On the basis of these instructions, the VR data controller 22 of the server 2 generates VR data for displaying the VR space including the active avatars A and C, and transmits the VR data to the VR terminals 1A and 1C. The VR space is displayed on the displays 11 of the VR terminals 1A and 1C on the basis of the VR data.

In this manner, the VR terminals 1A and 1C and the VR data controller 22 of the server 2 cooperate to display the VR space in which the avatars A and C are active on the displays 11 of the VR terminals 1A and 1C in response to the instructions of the users A and C (step S12).

Subsequently, the user A first makes a lending offer to lend the item P to the user C at an appropriate timing in order to sell the item P to the user C. That is, the VR terminal 1A transmits the lending offer to the server 2 in response to an input from the user A via the input interface 12 of the VR terminal 1A (step S13). In a case where the item P is a garment, the lending here corresponds to trial fitting. Note that the lending offer may be made at any timing, and may be made, for example, when the user A visually recognizes that the avatar A and the avatar C are sufficiently close to each other. In addition, it may be made when the user A operates the avatar A to talk to the avatar C.

When receiving the lending offer, the server 2 notifies the user C that the lending offer has been made, that is, that the item P can be borrowed from the user A (step S14). As a specific example, the notifier 24 cooperates with the VR data controller 22 to generate VR data such that the fact that the avatar A prompts the avatar C to borrow the item P is displayed in the VR space. As such VR data is transmitted to the VR terminal 1C, the notification of the lending offer is displayed on the display 11 of the VR terminal 1C (step S15).

Here, the avatar A and the avatar C may have a sales talk in the VR space before and after the lending. Marketing data can also be picked up from this sales talk.

In a case where the user C desires to borrow the item P, the user C makes a borrowing offer to borrow the item P from the user A. That is, when there is an input for transmission of the borrowing offer from the user C via the input interface 12 of the VR terminal 1C (YES in step S16), the VR terminal 1C transmits the borrowing offer to the server 2 (step S17). Note that the borrowing is desirably free of charge.

When the server 2 receives the borrowing offer, the item controller 26 generates a copy of the item P. Data of the copy is transmitted from the server 2 to the VR terminal 1C (step S18). In addition, when the borrowing offer is received, the information manager 25 registers information indicating that the user C has temporary ownership of the item P in the item information database.

As a result, the user C borrows the item P borrowed from the user A and can try the item P. For example, the user C uses the input interface 12 of the VR terminal 1C to give an instruction for the avatar C to try (for example, try fitting) the item P in the VR space. This instruction is transmitted from the VR terminal 1C to the server 2. On the basis of this instruction, the VR data controller 22 of the server 2 generates VR data for displaying the VR space including the avatar C trying the item P, and transmits the VR data to the VR terminals 1A and 1C. The VR space is displayed on the displays 11 of the VR terminals 1A and 1C on the basis of the VR data.

In this manner, the VR terminals 1A and 1C and the VR data controller 22 of the server 2 cooperate to display the VR space in which the avatar C tries the item P on the displays 11 of the VR terminals 1A and 1C in response to the instruction of the user C (step S19). Note that the VR space displayed on the VR terminal 1C at this time is desirably not the VR space viewed from the viewpoint of the avatar C but one viewed from the viewpoint of a third party. This is because the user C can easily view a state in which the avatar C is trying the item P.

The user A makes a sales offer to sell the item P to the user A at an appropriate timing. That is, the VR terminal 1A transmits the sales offer to the server 2 in response to an input from the user A via the input interface 12 of the VR terminal 1A (step S20). The sales offer may be made at any timing, and may be made, for example, when the avatar C is trying the item P.

When receiving the sales offer, the server 2 notifies the user C that the sales offer has been made, that is, that the user A can sell the item P (step S21). As a specific example, the notifier 24 cooperates with the VR data controller 22 to generate VR data such that the fact that the avatar A prompts the avatar C to purchase the item P is displayed in the VR space. As such VR data is transmitted to the VR terminal 1C, the notification of the sales offer is displayed on the display 11 of the VR terminal 1C (step S22).

In a case where the sales offer from the user A is the sales offer with the resale right, the notification desirably includes the sales price with the resale right and the sales price with only ownership. In addition, in a case where the sales offer from the user A is the sales offer with only ownership, the notification desirably includes the sales price with only ownership.

When desiring to purchase the item P, the user C makes a purchase offer to purchase the item P from the user A. That is, when there is an input for transmission of the purchase offer from the user C via the input interface 12 of the VR terminal 1C (YES in step S23), the VR terminal 1C transmits the purchase offer to the server 2 (step S24).

Note that, in the case where the sales offer from the user A is the sales offer with the resale right, the user C can make the purchase offer with the resale right or can make the purchase offer with only ownership. That is, the offer receiver 23 of the server 2 can receive the purchase offer with the resale right, or can receive the purchase offer with only ownership.

On the other hand, in the case where the sales offer from the user A is the sales offer with only ownership, the user C can make only the purchase offer with only ownership. That is, the offer receiver 23 of the server 2 can receive only the purchase offer with only ownership.

When the server 2 receives the purchase offer from the VR terminal 1C, the settlement manager 27 performs necessary settlement (step S25). Specifically, the settlement manager 27 collects money corresponding to the sales price from the user C. Then, the settlement manager 27 deposits part or all of the collected money to the user A. If the user A is the n (≥3)th-order or subsequent owner user, money is also deposited to the primary to (n−1)th-order owner users involved in the distribution of the item. Note that it is desirable for the settlement manager 27 to present a purchase contract to the user C before performing the settlement, and perform the settlement in a case where the user C agrees with the contract.

Subsequently, the item controller 26 of the server 2 copies the item P, and data of the copy is transmitted to the VR terminal 1C (step S26). As a result, the VR terminal 1C receives the data of the copy of the item P (step S27), and the user C can use the item P in the VR space.

Note that, in a case where the item P is purchased by making the purchase offer with the resale right, the user C can make the sales offer with the resale right and the sales offer with only ownership for the item P. That is, the offer receiver 23 of the server 2 can receive both the sales offers from the user C.

On the other hand, in a case where the item P is purchased by making the purchase offer with only ownership, the user C cannot make the sales offer with only ownership for the item P. That is, the offer receiver 23 of the server 2 cannot receive the sales offer with only ownership and the sales offer with the resale right from the user C.

In addition, the information manager 25 of the server 2 updates the user information and the item information (step S28).

Specifically, in a case where the user C makes the purchase offer with the resale right and purchases the item P, the information manager 25 registers information indicating that the user C has the copy of the item P with the resale right in the user information database (FIG. 4). On the other hand, in a case where the user C makes the purchase offer with only ownership and purchases the item P, the information manager 25 registers information indicating that the user C has only the ownership of the copy of the item P (that is, does not have the resale right) in the user information database. The above registration processing can also be said to be that the user C stores the item P in the virtual closet in the VR space.

Note that information indicating that the user A owns the original of the item P is maintained when any registration is performed.

In addition, the information manager 25 registers the user C as a user of the copy of the item P and updates the number of past sales and a turnover in the item information database (FIG. 5).

The updated user information may be transmitted to the VR terminal 1C and registered in the owned item information storage means 15.

In addition, some or all of the updated user information and item information (for example, the number of past sales, a turnover amount, information on a purchasing user, and the like) may be transmitted to the VR terminal 1A as distribution information (step S29) and referred to by the user A who is the original owner user (step S30). In a case where the user A is n (≥3)th-order or subsequent owner user, the distribution information may be transmitted to the primary to (n−1)th-order owner users involved in the distribution of the item.

As described above, the user C can purchase the item P from the user A. Note that the user A can continue to sell the item P to other users. That is, the offer receiver 23 of the server 2 can receive sales offers for the item P with respect to a plurality of users, and can receive purchase offers for the item P from a plurality of users.

Note that the user C may make purchase without borrowing in response to a lending offer from the user A. In that case, for example, it is sufficient that the user C informs the user A of a desire for the purchase without borrowing by talking to the avatar A from the avatar C in the VR space (NO in step S16 in FIG. 6) and the user A makes a sales offer in response thereto.

In addition, the user C does not have to purchase the item P in a case where the user C does not like the item P after borrowing or cannot agree to the sales price. In that case, for example, it is sufficient that the user C informs the user A that no purchase will be made by talking to the avatar A from the avatar C in the VR space (NO in step S23).

In addition, the user A may make a sales offer without making a lending offer. In this case, steps S13 to S19 are omitted.

In a case where the lending offer is made, the user A may be capable of setting a lending time as the lending offer. In this case, when the lending time elapses after the registration that the user C has the temporary ownership of the item P, the temporary ownership of the item P of the user C expires. That is, the information manager 25 registers information indicating that the user C does not have the temporary ownership of the item P in the user information database and the item information database.

In addition, in a case where the lending offer is made, the user A may be capable of setting an available area in the VR space of the item P to be lent as the lending offer. In this case, the avatar C as a borrower cannot use the item P outside the available area. Alternatively, the avatar C cannot move out of the available area in the state of using the item P.

In addition, the lending in the above-described embodiment assumes selling (for example, trial fitting), but may be rental. Also in this case, a user who makes the lending offer may be capable of setting the lending time or the available area in the VR space. In this case, it may be free or charged. In the case of being charged, the settlement manager 27 performs necessary settlement.

Note that whether or not to include the resale right in a set is set in the sales offer in the present embodiment, but the resale right may be granted after sale. That is, in response to an input operation from s user who owns a sale right, an instruction for validating a resale right of an item owned by a purchasing user is transmitted from the VR terminal to the server 2. In response to this, the information manager 25 of the server 2 may update the user information and the item information.

In addition, the original owner user may stop resale at any timing. That is, an instruction for invalidating the resale right owned by the purchasing user is transmitted from the VR terminal to the server 2 in response to an input operation from the original owner user. In response to this, the information manager 25 of the server 2 may update the user information and the item information.

In addition, money is paid as the consideration for purchase of an item in the present embodiment, but the consideration may be anything other than money, such as points (rewards) that can be used in the VR space. In the case of a consideration other than money, the terms “sale” and “purchase” apply. In addition, a consideration collected from a purchaser and a consideration given to a seller may be of different types. For example, the former may be money and the latter may be points (rewards) that can be used in the VR space.

In addition, the avatar is activated in the VR space according to the user input in the present embodiment, but an avatar that is a non-player character (NPC) programmed in advance may be automatically activated to perform sale. In this case, whether a user makes the sales offer with the resale right or makes the sales offer with only ownership is set in advance. Then, an instruction for granting the resale right to a purchasing user is transmitted from the VR terminal to the server 2 in response to an input operation of the user having a sale right for a certain item. In response to this, the information manager 25 of the server 2 may update the user information and the item information.

Any part of all of the respective functional units described in the present specification may be achieved by a program. The program referred to in the present specification may be distributed by being non-temporarily recorded in a computer-readable recording medium, may be distributed via a communication line (including wireless communication) such as the Internet, or may be distributed in a state of being installed in any terminal.

Any person skilled in the art may be able to conceive additional effects and various modifications of the present invention on the basis of the above description, but modes of the present invention are not limited to the individual embodiments described above. Various additions, alterations, and partial deletions can be made within a scope not departing from conceptual idea and intent of the present invention derived from the contents defined in the claims and equivalents thereof.

For example, what is described as a single device (or member, the same applies hereinafter) in the present specification (including what is depicted in the drawings as a single device) may be achieved by a plurality of devices. Conversely, what is described as a plurality of devices in the present specification (including what is depicted in the drawings as a plurality of devices) may be achieved by a single device. Alternatively, some or all of means and functions assumed to be included in a certain device (for example, the server) may be included in another device (for example, the VR terminal).

In addition, not all the matters described in the present specification are essential requirements. In particular, matters described in the present specification and not described in the claims can be regarded as any additional matters.

It should be noted that the applicant is merely aware of the invention disclosed the document in the section of “Citation List” in the present specification, and the present invention is not necessarily intended to solve the problem in the invention disclosed in the document. A problem to be solved by the present disclosure should be recognized by taking the entire specification into account. For example, in a case where there is a description that a specific configuration produces a predetermined effect in the present specification, it can also be said that a problem that is reverse to the predetermined effect is solved. However, such a specific configuration is not necessarily an essential requirement.

### REFERENCE SIGNS LIST

1A to 1C VR terminal
11 Display
12 Input interface
13 Controller
14 Communication module
15 Owned item information storage means
2 Server
21 Communication module
22 VR data controller
23 Offer receiver
24 Notifier
25 Information manager
26 Item controller
27 Settlement manager
28 User information storage means
29 Item information storage means

1. An item distribution control device that controls distribution of an item usable in a VR space, the item distribution control device comprising:
a sales offer receiver capable of receiving, from a first user having ownership and a sale right of the item,
a first sales offer for offering to sell a set of the ownership and a resale right of the item to another user, and
a second sales offer for offering to sell only the ownership of the item to another user;
a purchase offer receiver
in a case where the second sales offer is received, capable of receiving only a second purchase offer from another user among
a first purchase offer for offering to purchase the set of the ownership and the resale right of the item from the first user and
the second purchase offer for offering to purchase only the ownership of the item from the first user, and
in a case where the first sales offer is received, capable of receiving the first purchase offer or the second purchase offer from another user according to a choice of the another user; and
an information manager that
registers first information indicating that a second user has the ownership and the resale right of the item in a user information database in a case where the first purchase offer is received from the second user, and
registers second information indicating that the second user has the ownership of the item but does not have the resale right in the user information database in a case where the second purchase offer is received from the second user,
wherein the sales offer receiver
is capable of receiving a third sales offer for offering to sell the set of the ownership and the resale right of the item to another user and a fourth sales offer for offering to sell only the ownership of the item to another user from the second user in a case where the first information is registered, and
is incapable of receiving the third sales offer and the fourth sales offer from the second user in a case where the second information is registered.

2. The item distribution control device according to claim 1, further comprising a settlement manager that collects a consideration for the item from the second user and gives at least a part of the consideration to the first user in a case where the first purchase offer or the second purchase offer is received from the second user.

3. The item distribution control device according to claim 1, wherein
the purchase offer receiver is
in a case where the fourth sales offer is received, capable of receiving only a fourth purchase offer from another user among
a third purchase offer for offering to purchase the set of the ownership and the resale right of the item from the second user and
the fourth purchase offer for offering to purchase only the ownership of the item from the second user, and
in a case where the third sales offer is received, capable of receiving the third purchase offer or the fourth purchase offer from another user according to a choice of the another user, and
the information manager
registers third information indicating that a third user has the ownership and the resale right of the item in the user information database in a case where the third purchase offer is received from the third user, and
registers fourth information indicating that the third user has the ownership of the item but does not have the resale right in the user information database in a case where the fourth purchase offer is received from the third user.

4. The item distribution control device according to claim 3, further comprising a settlement manager that
collects a first consideration for the item from the second user and gives at least a part of the first consideration to the first user in a case where the first purchase offer or the second purchase offer is received from the second user, and
collects a second consideration for the item from the third user, gives a part of the second consideration to the first user, and gives at least a remaining part to the second user in a case where the third purchase offer or the fourth purchase offer is received from the third user.

5. The item distribution control device according to claim 1, wherein
information indicating that the first user has the ownership and the sale right of the item is registered in the user information database before the first sales offer or the second sales offer is received from the first user, and
the information indicating that the first user has the ownership and the sale right of the item is maintained in both cases where the first information is registered and where the second information is registered.

6. The item distribution control device according to claim 1, wherein the purchase offer receiver is capable of receiving the first purchase offer or the second purchase offer from a plurality of other users.

7. The item distribution control device according to claim 1, further comprising:
a lending offer receiver capable of receiving, from the first user, a lending offer for offering to lend the item to another user; and
a borrowing offer receiver capable of receiving, from another user, a borrowing offer for offering to borrow the item from the first user,
wherein the information manager registers fifth information indicating that a fourth user has temporary ownership of the item in the user information database in a case where the borrowing offer is received from the fourth user in response to the lending offer.

8. The item distribution control device according to claim 7, wherein
a lending time for lending the item to another user is set in the lending offer, and
the information manager registers sixth information indicating that the fourth user does not have primary ownership of the item in the user information database when a period of time according to the lending time elapses from the registration of the fifth information.

9. The item distribution control device according to claim 7, wherein an available area in the VR space of the item to be lent is set in the lending offer.

10. One or more non-transitory computer readable media storing an item distribution control program for controlling distribution of an item usable in a VR space, when the item distribution control program is executed by at least one processor of a computer, the computer functions as:
a sales offer receiver capable of receiving, from a first user having ownership and a sale right of the item,
a first sales offer for offering to sell a set of the ownership and a resale right of the item to another user, and
a second sales offer for offering to sell only the ownership of the item to another user;
a purchase offer receiver
in a case where the second sales offer is received, capable of receiving only a second purchase offer from another user among
a first purchase offer for offering to purchase the set of the ownership and the resale right of the item from the first user and
the second purchase offer for offering to purchase only the ownership of the item from the first user, and
in a case where the first sales offer is received, capable of receiving the first purchase offer or the second purchase offer from another user according to a choice of the another user; and
an information manager that
registers first information indicating that a second user has the ownership and the resale right of the item in a user information database in a case where the first purchase offer is received from the second user, and
registers second information indicating that the second user has the ownership of the item but does not have the resale right in the user information database in a case where the second purchase offer is received from the second user,
wherein the sales offer receiver
is capable of receiving a third sales offer for offering to sell the set of the ownership and the resale right of the item to another user and a fourth sales offer for offering to sell only the ownership of the item to another user from the second user in a case where the first information is registered, and
is incapable of receiving the third sales offer and the fourth sales offer from the second user in a case where the second information is registered.

11. An item distribution control method for controlling distribution of an item usable in a VR space, the item distribution control method comprising:
enabling a sales offer receiver to receive, from a first user having ownership and a sale right of the item,
a first sales offer for offering to sell a set of the ownership and a resale right of the item to another user, and
a second sales offer for offering to sell only the ownership of the item to another user;
enabling a purchase offer receiver
in a case where the second sales offer is received, to receive only a second purchase offer from another user among
a first purchase offer for offering to purchase the set of the ownership and the resale right of the item from the first user and
the second purchase offer for offering to purchase only the ownership of the item from the first user, and
in a case where the first sales offer is received, to receive the first purchase offer or the second purchase offer from another user according to a choice of the another user; and
a step of causing an information manager
to register first information indicating that a second user has the ownership and the resale right of the item in a user information database in a case where the first purchase offer is received from the second user, and
to register second information indicating that the second user has the ownership of the item but does not have the resale right in the user information database in a case where the second purchase offer is received from the second user,
wherein the sales offer receiver
is capable of receiving a third sales offer for offering to sell the set of the ownership and the resale right of the item to another user and a fourth sales offer for offering to sell only the ownership of the item to another user from the second user in a case where the first information is registered, and
is incapable of receiving the third sales offer and the fourth sales offer from the second user in a case where the second information is registered.

12. A VR terminal used by a user, the VR terminal comprising
a controller that
refers to an owned item information database indicating an item for which the user has ownership and a sale right and an item for which the user has ownership and does not have a sale right,
is capable of transmitting a first sales offer for offering to sell a set of the ownership and a resale right of the item to another user or a second sales offer for offering to sell only the ownership of the item to another user according to a choice of the user for the item for which the ownership and the sale right are owned, and
is incapable of transmitting the first sales offer and incapable of transmitting only the second sales offer for the item for which the ownership is owned but the sale right is not owned.

13. One or more non-transitory computer readable media storing a VR terminal program, when the VR terminal program is executed by at least one processor of a VR terminal used by a user, the VR terminal functions as
a controller that
refers to an owned item information database indicating an item for which the user has ownership and a sale right and an item for which the user has ownership and does not have a sale right,
is capable of transmitting a first sales offer for offering to sell a set of the ownership and a resale right of the item to another user or a second sales offer for offering to sell only the ownership of the item to another user according to a choice of the user for the item for which the ownership and the sale right are owned, and
is incapable of transmitting the first sales offer and incapable of transmitting only the second sales offer for the item for which the ownership is owned but the sale right is not owned.

14. A VR terminal control method, wherein
a VR terminal used by a user
refers to an owned item information database indicating an item for which the user has ownership and a sale right and an item for which the user has ownership and does not have a sale right,
is capable of transmitting a first sales offer for offering to sell a set of the ownership and a resale right of the item to another user or a second sales offer for offering to sell only the ownership of the item to another user according to a choice of the user for the item for which the ownership and the sale right are owned, and
is incapable of transmitting the first sales offer and incapable of transmitting only the second sales offer for the item for which the ownership is owned but the sale right is not owned.
